(19) United States
(12) Patent Application Publication
(10) Pub. No.: US 2011/0131648 A1
(43) Pub. Date: Jun. 2, 2011

(54) Method and System for Digital Communication Security Using Computer Systems

(75) Inventor: Charles Dunelm Gargett, Lathlain (AU)

(73) Assignee: IWEBGATE TECHNOLOGY LIMITED, Perth (AU)

(21) Appl. No.: 12/957,042

(22) Filed: Nov. 30, 2010

Related U.S. Application Data
(60) Provisional application No. 61/265,196, filed on Nov. 30, 2009.

(51) Int. Cl. G06F 17/00; H04L 29/06

(52) U.S. Cl. 726/15; 726/3

(57) ABSTRACT

Methods and systems are provided for network security. In one embodiment, the method may involve receiving a data packet (e.g. from a firewall). The method may involve running an inspection of the received data packet within a virtual network, the virtual network duplicating at least a portion (e.g., servers(s) and/or application(s)) of a protected network. The method may involve sending the inspected data packet, or portion and/or modified version thereof, to the protected network, in response to the data packet passing the inspection within the virtual network. The method may also involve blocking passage of the data packet to the protected network, in response to the data packet failing the inspection.

### CROSS-REFERENCE TO RELATED APPLICATIONS

This application claims the benefit of U.S. Provisional Application No. 61/265,196, entitled “Method for Digital Communication Security Using Computer Systems,” filed Nov. 30, 2009, which is hereby expressly incorporated in its entirety by reference herein.

### BACKGROUND

1. Field

The present application relates generally to communication security, and more particularly to computer-implemented security techniques for implementing a ghost/virtual network to protect a client network.

2. Background

The primary method of protecting a computer network from attacks is a device called a firewall. The majority of modern firewalls protect a network by limiting what communication channels or “ports” are used by outside users wishing to connect with a protected network. In a standard firewall no additional investigation of the incoming communications is done beyond confirming that the incoming message is going to an allowed or authorized port that has been left open for the use of visitors by the network administrator. Other ports are turned off and no communication is allowed through them.

A common method of abusing this means of network protection is cloaking attack data within packets that are labeled differently so that the firewall allows the data to pass through an authorized port to the network. The cloaked communications then reach an unprotected application within the protected network and use weaknesses in the design of that application to continue on to do the intended abuse and or damage.

Other more powerful and expensive types of firewalls go further in interrogating the incoming information, however this is an expensive, time consuming and highly customized application of firewall technology and as a result is not used widely on the Internet as a security method. Accordingly, there is a need for a network security system that overcomes the above-described disadvantages of firewalls and known communication security techniques.

### SUMMARY

In accordance with one or more embodiments and corresponding disclosure thereof, various aspects are described in connection with a method performed by a virtual entity (e.g., virtual computing device, processor, or application). The method may generally relate to generating and using a ghost or virtual duplicate of components (e.g., server(s) and/or application(s)) of a protected network to pre-screen data. The method may involve receiving a data packet (e.g., from a firewall). The method may involve running an inspection of the received data packet within a virtual network, the virtual network duplicating at least a portion of a protected network. The method may involve sending the inspected data packet (or portion and/or modified version thereof) to the protected network, in response to the data packet passing the inspection within the virtual network.

In related aspects, the protected network may comprise at least one protected server. The at least one protected server may comprise at least one protected application. The virtual network may comprise at least one virtual server, the at least one virtual server being a ghost of the at least one protected server. The at least one virtual server may comprise at least one virtual application, the at least one virtual application being a virtual duplicate of the at least one protected application.

In further related aspects, running the inspection may involve applying a pre-application security utility. In addition, or in the alternative, running the inspection may involve applying a post-application security utility. In yet further related aspects, the method may involve blocking passage of the data packet to the protected network, in response to the data packet failing the inspection.

In accordance with aspects of the embodiments described herein, there is provided a system for network security, comprising: a protected network comprising at least one protected server; and a virtual network comprising at least one virtual server. The at least one virtual server may be a ghost of the at least one protected server and may be configured to: receive a data packet; run an inspection of the received data packet; and send the inspected data packet to the protected network, in response to the data packet passing the inspection. In one embodiment, the virtual network is a virtual duplicate of the protected network. In another embodiment, the virtual network may include ghost(s) of a subset of the components (e.g., server(s) and/or application(s)) of the protected network.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other novel features will become apparent from the following detailed description when considered in conjunction with the drawings and the disclosed aspects are intended to include all such aspects and their equivalents.

### BRIEF DESCRIPTION OF THE DRAWING

FIG. 1 shows a known advanced firewall system.

FIG. 2 provides a general overview of an exemplary communication system.

FIG. 3 illustrates an embodiment of communication system with a virtual network.

FIG. 4 shows an overview of an embodiment of a network security system with a ghost virtual network.

FIG. 5 illustrates an example methodology for network security.

FIG. 6 shows further aspects of the methodology of FIG. 5.

FIG. 7 illustrates an exemplary apparatus for network security.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

In existing network security devices, such as a firewall, attempts to send information using the wrong port number are thwarted by disabling the corresponding port on the firewall. This in turn limits access to the protected network by allowing communications through the network to legitimate existing applications. However even this security measure may be thwarted by the cloaking of damaging data inside seemingly legitimate packets of information that will eventually allow access to the client network environment behind the firewall.

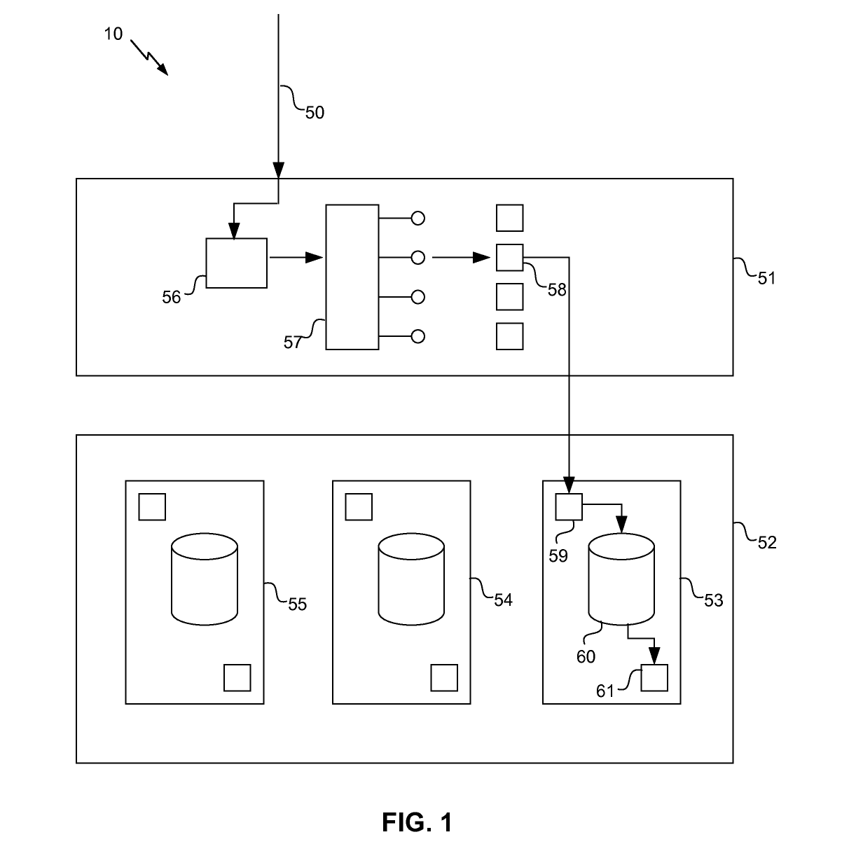

FIG. 1 illustrates a known advanced firewall system. Specifically, FIG. 1 shows a system 10 for detection of network attacks, comprising an intelligent firewall 51 that not only limits what port the data 50 can come into but also interrogates the data 50 using a packet analyzer 56 that then determines what type of data it is but then sends it for verification 57 and for testing 58 before allowing it to be sent on to the appropriate server 53 within the client/secure/protected network 52. The server 53 may comprise a component 60 for using/processing the data 50, wherein the component 60 may comprise a memory, disk drive, processor, application, applet, firmware, or combinations thereof. The protected network may further include servers 54, 55. Such systems are often used in high security situations and the intelligent firewalls 51 can be very expensive. Additionally, the maintenance of the data testing routines 58 and the continual upgrade of attack countermeasures can be very intensive and expensive compared to the security measures used within the operating system to protect data as it is checked before the application is used, at 59, and after it has been processed, at 61, and is sent on for further use within the protected network environment 52. Further, these advanced firewall systems often fail to or are unable to interrogate the payload of encrypted packets (on layer 3 and up) prior to forwarding the packet to the protected network because the encryption negotiation is not performed with the firewall as the end-point.

The embodiments described below present techniques for implementing a virtual network to protect a client/internal/secure/trusted/protected network. It is desirable that, for end-users, each of the network services have the appearance of working together seamlessly on one operating system residing on a single server. Such an outcome may be achieved by: emulating network engineering through software on a single appliance; and isolating each service in the platform individually without affecting the performance or reliability of the service, and without preventing communication with other “co-hosted” services within the appliance.

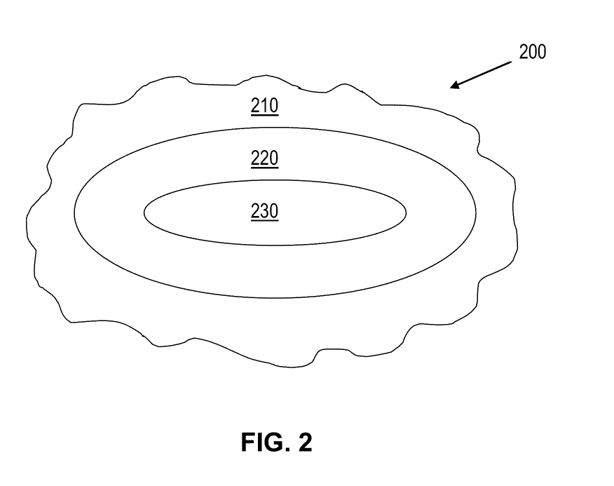

In accordance with aspects of the embodiments described herein, the network security techniques described herein may be deployed in a virtual network zone, which is analogous to a demilitarized zone. With reference to FIG. 2, there is shown a communication system 200 that includes a virtual/ghost network 220 between a volatile public network 210 (e.g., the Internet) and a secure/trusted/protected network 230. By deploying verification or screening inspections/tests in the virtual network 220, it is possible to prevent direct exposure of the protected network 230 to the public network 210. Examples of such inspections/tests may include, but are not limited to, reverse proxies, bridging services packet inspection routines, relaying services (e.g., email), and/or intrusion detection/prevention systems.

In related aspects, the system 200 may treat the protected network 230 as alien and untrusted, but may be configured to seamlessly work with the protected network 230 over a Local Area Network (LAN) infrastructure or the like. Similarly, the virtual network 220 be configured to have the same seamless capacity to work with multiple alien networks that may be located remotely (i.e., securely over the Internet). Therefore, the system is able to work bi-directionally whereby traffic destined for the remote networks (including the Internet), public or otherwise, can be interrogated in a manner equal to that of traffic destined for the protected network.

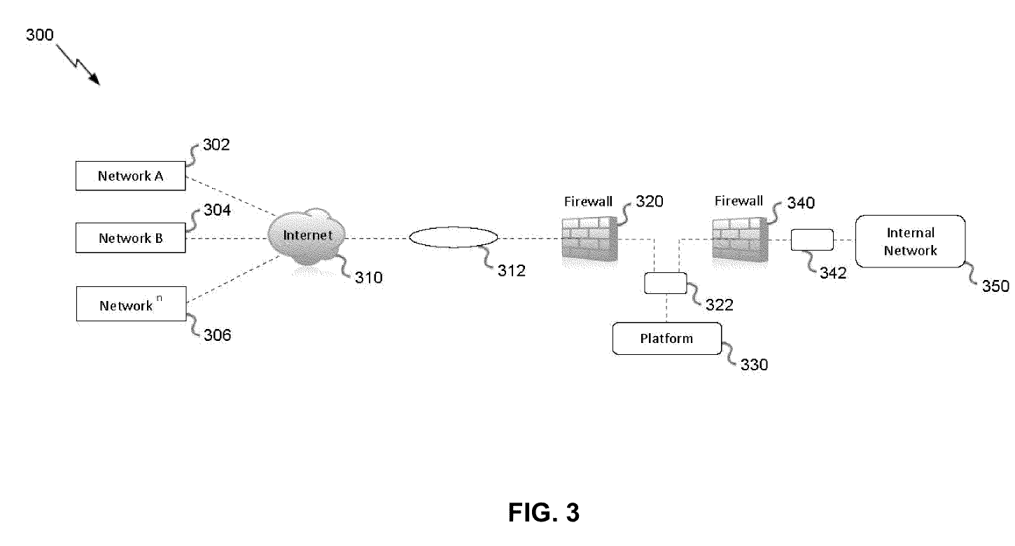

With reference to FIG. 3, there is shown an exemplary communication system 300 that comprises networks 302, 304, 306, each of which may be in communication with the Internet 310, which in turn may be in communication with a perimeter firewall 320 or the like, via a communication link 312 that may include or utilize Digital Subscriber Line (DSL) or the like. The perimeter firewall 320 may be in communication with a virtual network/platform 330, optionally via a switching device 322 or the like.

The virtual network 330, optionally via a switching device 322 or the like, may be in communication with an internal firewall 340. The internal firewall 340 may be in communication with an internal secure/trusted network 350, optionally via a switching device 342 or the like. The protected network 350 may include one or more servers, wherein each server may include one or more applications, as explained in further detail below.

It is noted that the virtual network 330 is shown to be located in between the perimeter firewall 320 and the internal firewall 340 in the embodiment of FIG. 3. However, in another embodiment (not shown), the ghost/virtual network may be setup in front of the perimeter firewall. In yet another embodiment, the ghost/virtual network may be on the private/trusted network itself (e.g., on an internal switching device/component). In still another embodiment, the ghost/virtual network may sit at the Internet Service Provider (ISP) or the like.

In accordance with aspects of the embodiments described herein, techniques are provided for addressing network security issues by producing a duplicate safe clone or ghost of the protected network and allowing intelligent system level interrogation of the incoming network requests and data to be executed before the request is passed on to the protected network, servers, and applications.

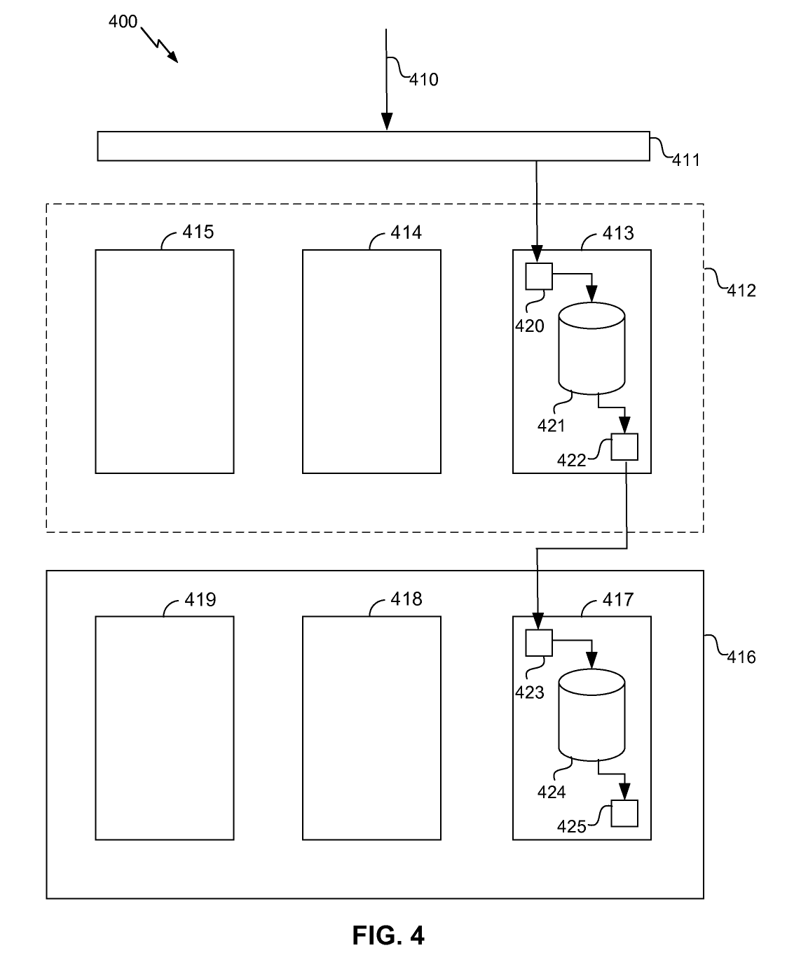

FIG. 4 illustrates an embodiment of an improved network security system 400. The data 410 comes into the optional firewall 411, but before it is passed onto the existing secure/protected network 416 it is passed through a duplicate or ghost virtual network 412 that may be identical to the protected network in terms of applications and servers. Each server 417, 418, 419 on the internal protected network 416 may have a copy or ghost service 413, 414, 415 in the duplicate or ghost virtual network 412. The same may be true of each component (e.g., application) on each server. An application 424 on the protected network 416 may have a duplicate or ghost application 421 on the ghost virtual network 412.

An advantage of this technique is that the data inspection and security utility 423 that inspects data before use and the utility 425 that inspects data after use by the application 424 can also be used by the ghost application 421 and its pre-application security utility 420 and post application data security utility 422 on the ghost network 412 before the data is handed over for use by the application 424 on the protected network 416. The result is that the powerful and well maintained security and anti-hacking countermeasures (e.g., system hardening, traffic filtering and scanning (bi-directionally), reverse proxies, connection authorization, and/or service isolation) can be used to pre-screen data in a safe ghost network 412 environment before it enters a secure internal protected network 416.

It is noted that a ghost virtual network need not be a complete duplicate of the internal network it protects. In one embodiment, the virtual network may comprise one duplicate application on a single server or virtual server configured to pre-process incoming data or requests and verifying the information before sending it on to the destination application.

It is further noted that a system 400 for network security may include a protected network 416 that comprises at least one protected server (e.g., servers 417, 418, and 419), as well as a virtual network 412 that comprises at least one virtual server (e.g., virtual servers 413, 414, and 415). The at least one virtual server (e.g., virtual servers 413, 414, and 415) may be a ghost of the at least one protected server (servers 417, 418, and 419, respectively) and may be configured to: receive a data packet (e.g., data 410); run an inspection of the received data packet; and send the inspected data packet to the protected network (e.g., internal network 416), in response to the data packet passing the inspection. In related aspects, the virtual network 412 may be a ghost or virtual duplicate of the protected network 416. The at least one virtual server may receive the data packet from a firewall or the like.

In further related aspects, the at least one protected server may comprise at least one protected application. The at least one virtual server may comprise at least one virtual application, the least one virtual application being a virtual duplicate of the protected application. For example, the at least one virtual server may run the inspection by applying a pre-application security utility (e.g., intrusion detection/prevention, incoming packet filtering, or the like, or combinations thereof). In addition, or in the alternative, the at least one virtual server may run the inspection by applying a post-application security utility (e.g., outgoing packet filtering, service traffic control (e.g., email), or the like, or combinations thereof). In yet further related aspects, the at least one virtual server may block passage of the data packet to the protected network, in response to the data packet failing the inspection.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable way (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

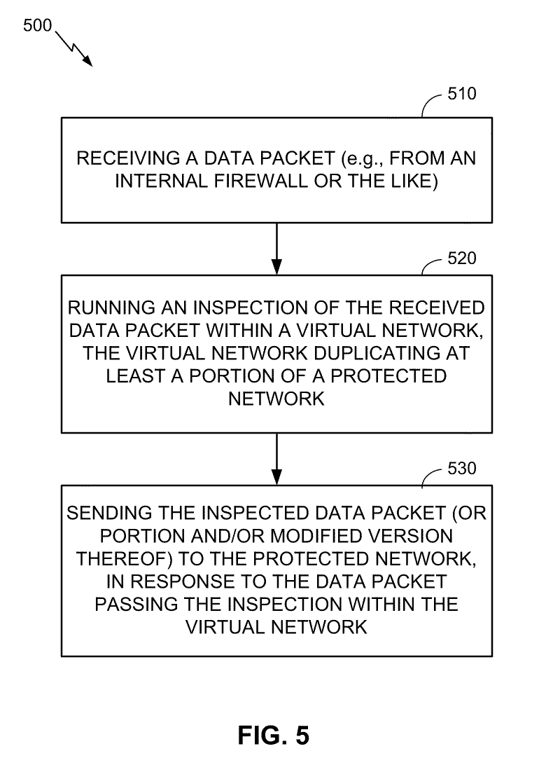

In accordance with one or more aspects of the embodiments described herein, there is provided a method for network security. With reference to FIG. 5, illustrated is a methodology 500 that may be performed by at least one computing device. In one embodiment, the method 500 may be performed by a virtual entity (e.g., a virtual network, at least one virtual server of the virtual network, and/or at least one virtual application of the at least one virtual server). The method 500 may involve, at 510, receiving a data packet (e.g., from an internal firewall or the like). The method 500 may involve, at 520, running an inspection of the received data packet within a virtual network, the virtual network duplicating at least a portion of a protected network. The method 500 may involve, at 530, sending the inspected data packet (or portion and/or modified version thereof) to the protected network, in response to the data packet passing the inspection within the virtual network.

In related aspects, the protected network may comprise at least one protected server. The at least one protected server may comprise at least one protected application. The virtual network may comprise at least one virtual server, the at least one virtual server being a ghost of the at least one protected server. The at least one virtual server may comprise at least one virtual application, the at least one virtual application being a virtual duplicate of the at least one protected application.

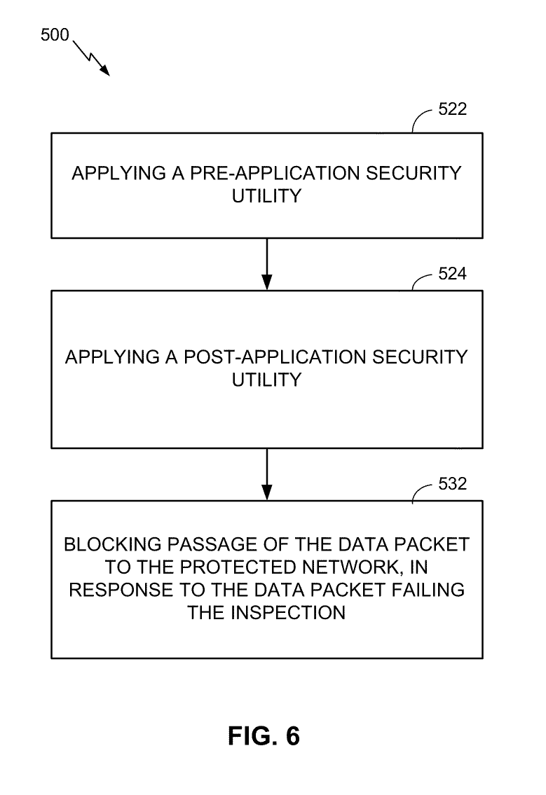

With reference to FIG. 6, running the inspection, may involve, at 522, applying a pre-application security utility. In addition, or in the alternative, running the inspection may involve, at 524, applying a post-application security utility. In further related aspects, the method 500 may involve, at 532, blocking passage of the data packet to the protected network, in response to the data packet failing the inspection.

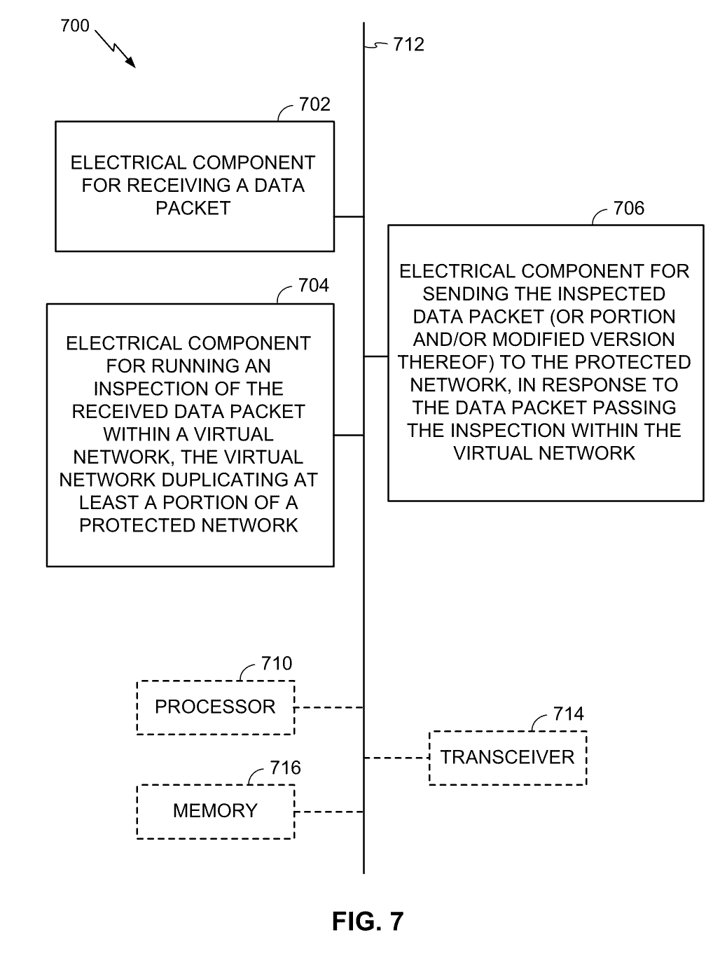

In accordance with one or more aspects of the embodiments described herein, there are provided devices and apparatuses for executing the pre-screening of data, as described above with reference to FIGS. 5-6. With reference to FIG. 7, there is provided an exemplary apparatus 700 that may be configured as an actual or virtual computing device, processor and/or similar device for use within the computing device. The apparatus 700 may include functional blocks that can represent functions implemented by an actual or virtual processor, software, or combination thereof (e.g., firmware).

As illustrated, in one embodiment, the apparatus 700 may comprise an electrical component or module 702 for receiving a data packet. The apparatus 700 may comprise an electrical component 704 for running an inspection of the received data packet within a virtual network, the virtual network duplicating at least a portion of a protected network. The apparatus 700 may comprise an electrical component 706 for sending the inspected data packet (or portion and/or modified version thereof) to the protected network, in response to the data packet passing the inspection within the virtual network.

In related aspects, the apparatus 700 may optionally include a processor component 710 having at least one processor, in the case of the apparatus 700 configured as a computing network entity, rather than as a processor. The processor 710, in such case, may be in operative communication with the components 702-706 via a bus 712 or similar communication coupling. The processor 710 may effect initiation and scheduling of the processes or functions performed by electrical components 702-706.

In further related aspects, the apparatus 700 may include a communication component 714 (e.g., an Ethernet interface module, radio transceiver module, etc.). The apparatus 700 may include a component for storing information, such as, for example, a memory device/component 716. The computer readable medium or the memory component 716 may be operatively coupled to the other components of the apparatus 700 via the bus 712 or the like. The memory component 716 may be adapted to store computer readable instructions and data for effecting the processes and behavior of the components 702-706, and subcomponents thereof, or the processor 710, or the methods disclosed herein. The memory component 716 may retain instructions for executing functions associated with the components 702-706. While shown as being external to the memory 706, it is to be understood that the components 702-716 can exist within the memory 716.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes Compact Disc (CD), laser disc, optical disc, Digital Versatile Disc (DVD), floppy disk and Blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system for network security, comprising:
a protected network comprising at least one protected server; and
a virtual network comprising at least one virtual server;
wherein the at least one virtual server is a ghost of the at least one protected server and is configured to:
receive a data packet;
run an inspection of the received data packet; and
send at least a portion of the inspected data packet to the protected network, in response to the data packet passing the inspection.

2. The system of claim 1, wherein the virtual network is a virtual duplicate of the protected network.

3. The system of claim 1, wherein the at least one virtual server receives the data packet from a firewall.

4. The system of claim 1, wherein:
the at least one protected server comprises a protected application; and
the at least one virtual server comprises at least one virtual application, the least one virtual application being a virtual duplicate of the protected application.

5. The system of claim 4, wherein the at least one virtual server runs the inspection by applying at least one of a pre-application security utility and a post-application security utility.

6. The system of claim 1, wherein the at least one virtual server blocks passage of the data packet to the protected network, in response to the data packet failing the inspection.

7. The system of claim 1, wherein the portion comprises a modified version of the inspected data packet.

8. A method operable by a virtual entity in a network system, comprising:
receiving a data packet;
running an inspection of the received data packet within a virtual network, the virtual network duplicating at least a portion of a protected network; and
sending at least a portion of the inspected data packet to the protected network, in response to the data packet passing the inspection within the virtual network.

9. The method of claim 8, wherein the virtual entity comprises one of (a) the virtual network, (b) at least one virtual server of the virtual network, and (c) at least one virtual application of the at least one virtual server.

10. The method of claim 8, wherein receiving comprises receiving the data packet from a firewall.

11. The method of claim 8, wherein:
the protected network comprises at least one protected server;
the at least one protected server comprises at least one protected application;
the virtual network comprises at least one virtual server, the at least one virtual server being a ghost of the at least one protected server; and
the at least one virtual server comprises at least one virtual application, the at least one virtual application being a virtual duplicate of the at least one protected application.

12. The method of claim 11, wherein running the inspection comprises applying at least one of a pre-application security utility and a post-application security utility.

13. The method of claim 8, further comprising blocking passage of the data packet to the protected network, in response to the data packet failing the inspection.

14. The method of claim 8, wherein the portion comprises a modified version of the inspected data packet.

15. A computer program product, comprising:
a computer-readable medium comprising code for causing a computer to:
receive a data packet;
run an inspection of the received data packet within a virtual network, the virtual network duplicating at least a portion of a protected network; and
send at least a portion of the inspected data packet to the protected network, in response to the data packet passing the inspection within the virtual network.

16. The computer program product of claim 15, wherein the computer-readable medium further comprises code for causing the computer to receive the data packet from a firewall.

17. The computer program product of claim 15, wherein:
the protected network comprises at least one protected server;
the at least one protected server comprises at least one protected application;
the virtual network comprises at least one virtual server, the at least one virtual server being a ghost of the at least one protected server; and
the at least one virtual server comprises at least one virtual application, the at least one virtual application being a virtual duplicate of the at least one protected application.

18. The computer program product of claim 17, wherein the computer-readable medium further comprises code for causing the computer to apply at least one of a pre-application security utility and a post-application security utility.

19. The computer program product of claim 15, wherein the computer-readable medium further comprises code for causing the computer to block passage of the data packet to the protected network, in response to the data packet failing the inspection.

20. The computer program product of claim 15, wherein the portion comprises a modified version of the inspected data packet.
